(19) United States
(12) Patent Application Publication
(10) Pub. No.: US 2012/0186460 A1
(43) Pub. Date: Jul. 26, 2012

(54) DIVIDER APPARATUS FOR A ROLLER GRILL

(75) Inventors: James E. Humphrey, Cheyenne, WY (US); Anthony Kukla, Fort Collins, CO (US)

(73) Assignee: STANDEX INTERNATIONAL CORPORATION, Salem, NH (US)

(21) Appl. No.: 13/346,861

(22) Filed: Jan. 10, 2012

Related U.S. Application Data
(60) Provisional application No. 61/460,963, filed on Jan. 11, 2011.

(51) Int. Cl. A47J 37/04

(52) U.S. Cl. 99/339; 99/393; 99/441

(57) ABSTRACT

A divider apparatus for a roller grill. The invention has three main components: a front having front slots; a rear rail having rear slots; and at least one divider bar. There are three front rail variations, two major divider variations and four rear rail variations, thus providing a total of at least nine permutations and combinations by mixing and matching the apparatus components to enable the grill cooking surface to be divided into multiple cooking sections for different products to be cooked thereon. It can be retrofitted to fit on any size roller grill including grills with sneeze guards. It can also be attached without restricting access to the front of the roller grill so that products can be easily removed or placed on the grill or blocking the view or cleaning of the grill.

This application claims benefit of U.S. Provisional Application Ser. No. 61/460,963, filed Jan. 11, 2011, pursuant to 35 USC §119(e)

### FIELD OF THE INVENTION

This invention relates to commercial cooking equipment, in particular, a divider assembly for a roller grill for cooking hot dogs, bratwursts, sausages, and other food products having an elongated shape.

### BACKGROUND OF THE INVENTION

The use of a roller grill to cook hot dogs dates back at least as early as 1939. At that time, Dumas, in U.S. Pat. No. 2,185,979, recognized the advantage of using a plurality of rollers to quickly and uniformly cook hot dogs or other similar shaped foods. Since that time, the roller grill has been associated with America's food icon, the hot dog.

Despite numerous improvements to this device over the years, it wasn't until recently (Gaskill et al., in U.S. Pat. No. 7,367,261 issued May 6, 2008) recognized the advantage of being able to divide the cooking area of the roller grill into two or more sections yet having one set of rollers. In this manner, it became possible to cook different lengths of products or different type of products in their own section on the grill-cooking surface. Gaskill disclosed a section divider that was attached onto the roller tubes of the grill. While this provided two or more sections, depending on the number of dividers utilized, the method of attachment to provide these divided sections made changing the section sizes difficult. Further, each attachment to the roller tubes required a bearing assembly so that the rollers would be able to turn freely. Also, by being attached to the rollers of the grill, this arrangement impeded cleaning the grill of burned-on grease, especially in the vicinity of the bearing assembly of the divider. This made it highly likely that eventually the rollers rotation would be eventually restricted, if not stopped entirely.

In an improvement over this design, Gaskill et al. filed a continuation-in-part application that issued as U.S. Pat. No. 7,334,517 on Feb. 26, 2008. In this design, the divided sections were provided by rectangular shaped divider bars that were supported above the roller tubes by front and rear brackets. While this eliminated the problems of the divider/roller tube interface and cleaning difficulties around the tube/divider interface found with the earlier design, this variation presented new ones. The use of the front and rear brackets impeded the visual display of the cooking products and also interfered with access to the grill for removal and placement of products to be cooked. Further, this design still presents grill cleaning problems, especially the roller tubes adjacent to the front and rear brackets unless the device is removed from the grill.

A divider apparatus for a roller grill that is easily retrofitted to any roller grill; that does not interrupt the visual display of the products being cooked on the grill; does not restrict access for product placement or removal with the dividers in place; permits the grill to be cleaned, and can be easily changed into different sized sections, is not found in the prior art.

### SUMMARY OF THE INVENTION

It is an aspect of the invention to provide a roller grill divider assembly that can be adapted to fit on any size roller grill including grills with sneeze guards.

It is another aspect of the invention to provide a roller grill divider assembly that can be attached without restricting access to the front of the roller grill so that products can be easily removed or placed on the grill.

It is still another aspect of the invention to provide a roller grill divider assembly that permits easy cleaning of the grill roller tubes.

Another aspect of the invention is to provide a roller grill divider assembly that adapted to provide different mounting methods that are easily attached and removed while still meeting the merchandizing, visual attributes and cleanability requirements specified herein.

Still another aspect of the invention is to provide a roller grill divider assembly that be inexpensively manufactured.

Another aspect of the invention is to provide a roller grill assembly that does not visually impair a customer's view of the products while being grilled.

Finally, it is another aspect of the invention to provide a roller grill divider assembly that can be easily retrofitted to grills already in the field without requiring the grills to be sent back to the factory for installation.

### BRIEF DESCRIPTION OF THE DRAWINGS

FIG. 1 is an isometric view of the divider apparatus in accordance with the invention on a standard roller grill.

FIG. 2 is an exploded isometric view of the divider apparatus shown in FIG. 1.

FIG. 3 is a detailed isometric view of the attachment of the front rail to the roller grill.

FIG. 4 is a side view of the attachment of the front rail shown in FIG. 3.

FIG. 5 is a side view of the attachment of the front rail shown in FIG. 4 with pin removed.

FIG. 6 is a side view of the attachment of the rear rail to the roller grill.

FIG. 7 is an isometric view of an alternative embodiment of the divider apparatus.

FIG. 8 is an exploded isometric view of the alternative embodiment shown in FIG. 7.

FIG. 9 is side view of the alternative embodiment shown in FIG. 7.

FIG. 10 is a detailed side view of the attachment of the rear rail in the alternative embodiment shown in FIG. 7.

FIG. 11 is an isometric view of a second alternative embodiment of the divider apparatus.

FIG. 12 is an exploded isometric view of the second alternative embodiment shown in FIG. 11.

FIG. 13 is a detailed isometric view of the attachment of the front rail to the roller grill using the second alternative embodiment shown in FIG. 11.

FIG. 14 is a detailed side view of the attachment front rail in the second alternative embodiment shown in FIG. 11.

FIG. 15 is an isometric view of a third alternative embodiment of the divider apparatus.

FIG. 16 is a detailed isometric view of the attachment front rail in the third alternative embodiment shown in FIG. 15.

FIG. 17 is a side view of the attachment front rail in the third alternative embodiment shown in FIG. 15.

### DETAILED DESCRIPTION OF THE INVENTION

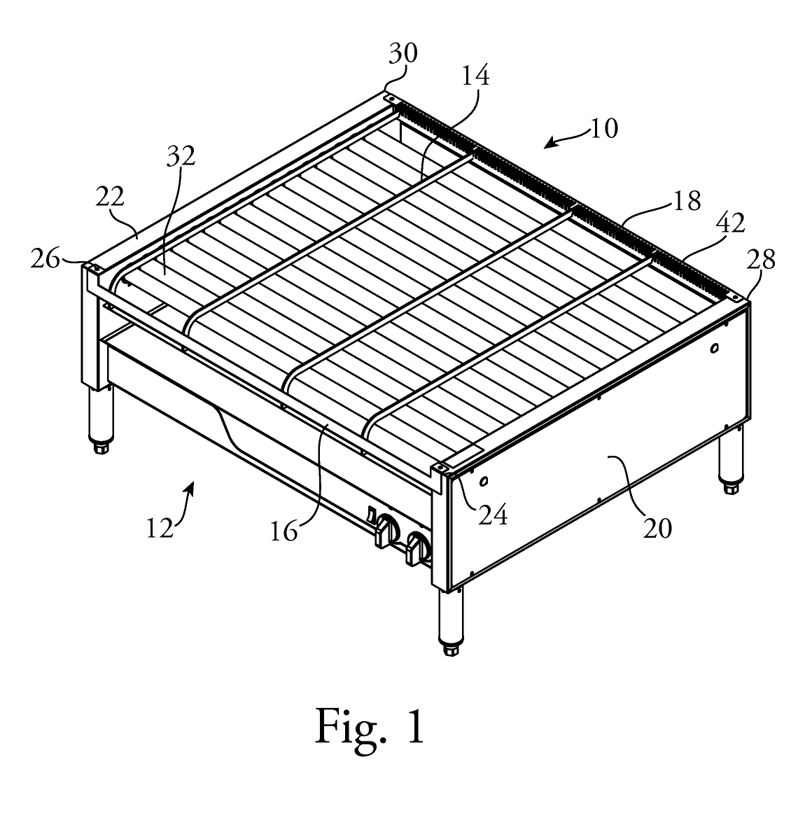

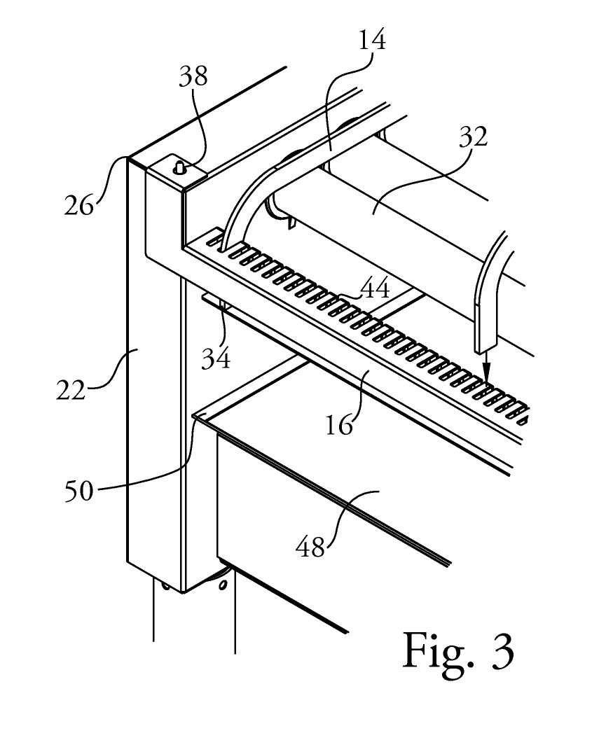

The invention is a divider apparatus for a roller grill. As shown in FIGS. 1,2 invention 10 has three main components: front rail 16 having front slots 44 (see. FIG. 3); rear rail 18 having rear slots 42; and at least one divider bar 14. There are three front rail variations, two major divider variations and four rear rail variations, thus providing a total of at least nine permutations and combinations by mixing and matching the apparatus' components.

The preferred embodiment is shown in FIG. 1 attached to typical roller grill 12 such as APW Wyott Model HRS-75. This embodiment features front rail 16 that is attached to roller grill 12 at the left front corner 26 of left panel 22 and right front corner 24 of right panel 20 of roller grill 12. Rear rail 18 is attached to left rear corner 30 of left panel 22 and attached to right rear corner 28 of right panel 20 in the same manner as front rail 16.

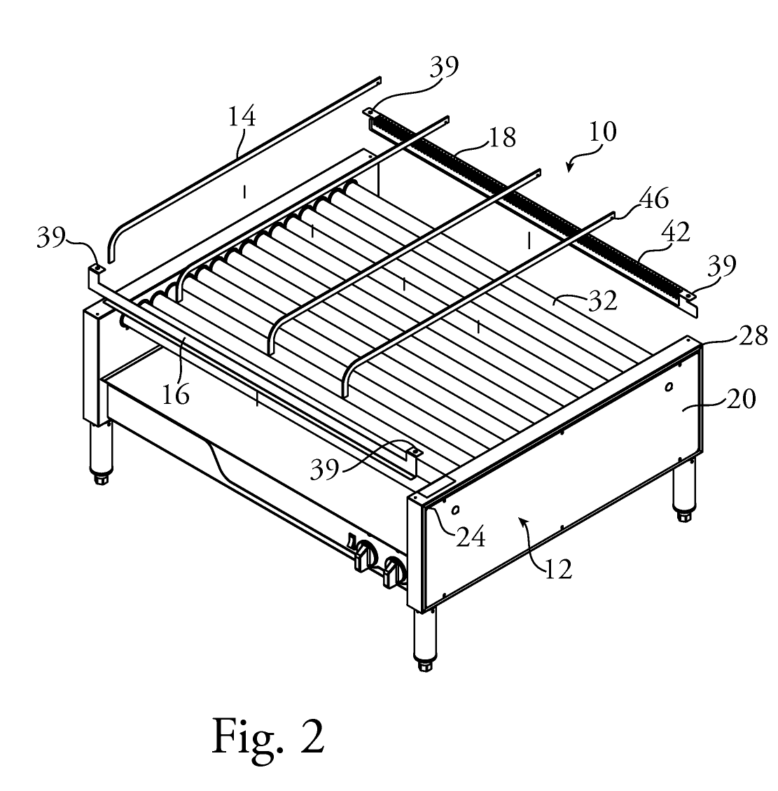

As shown in FIGS. 2, 3 and 4, front rail 16 is attached to left panel 22 via pin 38 through opening 39 in front rail 16. Similarly, front rail 16 is attached to right panel 20 by its pin 38 through its opening 39. Note that front end 34 of L-shaped bar 14 is inserted into one of slots 44 and held at the proper distance from roller tubes 32 via flange 40. Front rail 16 is positioned lower than roller tubes 32 so that the view of the grill and its cooking products is unobstructed. Also, products can be easily removed or placed on tubes 32 without bumping into front rail 16. Further, drip pan 48 that is supported by floor 50 is capable of being removed and replaced without first removing invention 10.

Front rail 16 is formed from a sheet of stainless steel using a sheet metal brake or other methods well known in the art. L-shaped bar 14 is made from a single piece of metal, preferably about ½ inch wide and ⅛ inch thick so that the length of leg 34 and leg 36 is such that bar 14 fits into a pair of aligned slots 42 and 44.

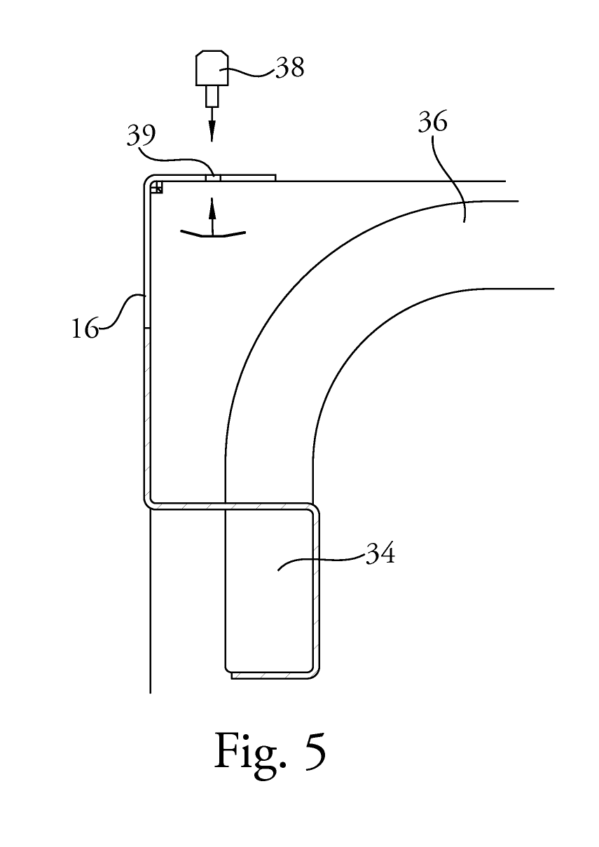

As shown in FIG. 5, front rail 16 can be easily be attached to left panel 22 by inserting pin 38 into left panel 22 by screwing or other well-known fastening means and then hanging rail 16 thereon by inserting pin 38 through opening 39. Similarly, front rail 16 is attached to right panel 20 using the same arrangement (not shown in detail). While the radius of the arc joining leg 34 and leg 36 of L-shaped bar 14 is not critical, it should have sufficient radius, as shown, in order to provide a smooth flowing transition.

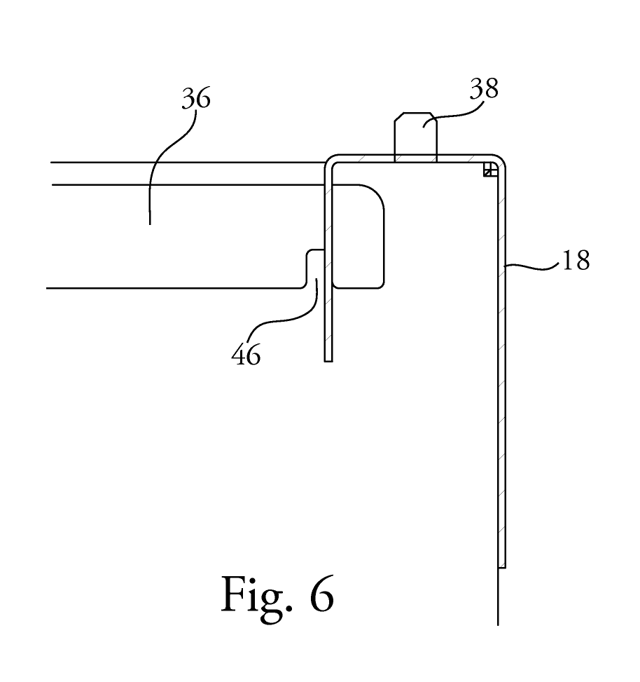

Referring to FIG. 6, rear rail 18 is attached to left panel 22 in the same manner using opening 39 in rear rail 18 and pin 38. Note that leg 36 of bar 14 has a notch 46 that locks bar 14 to rail 18.

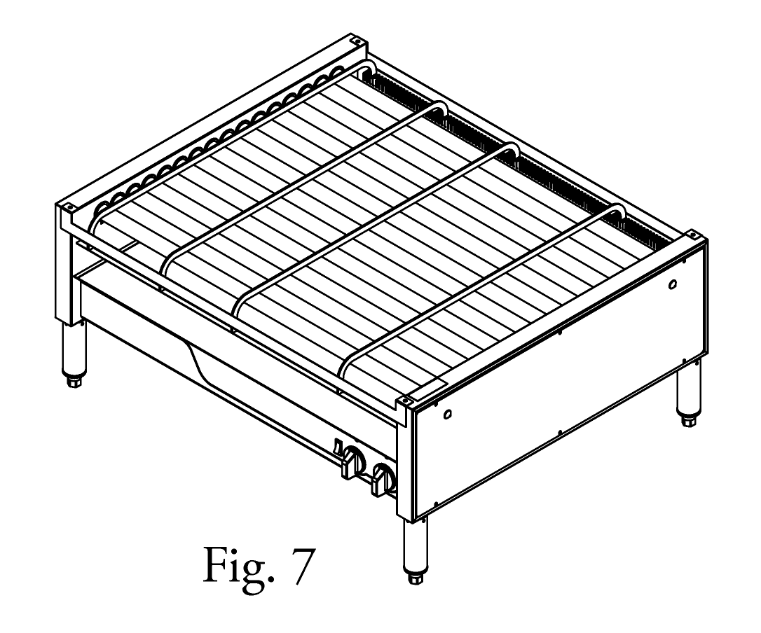

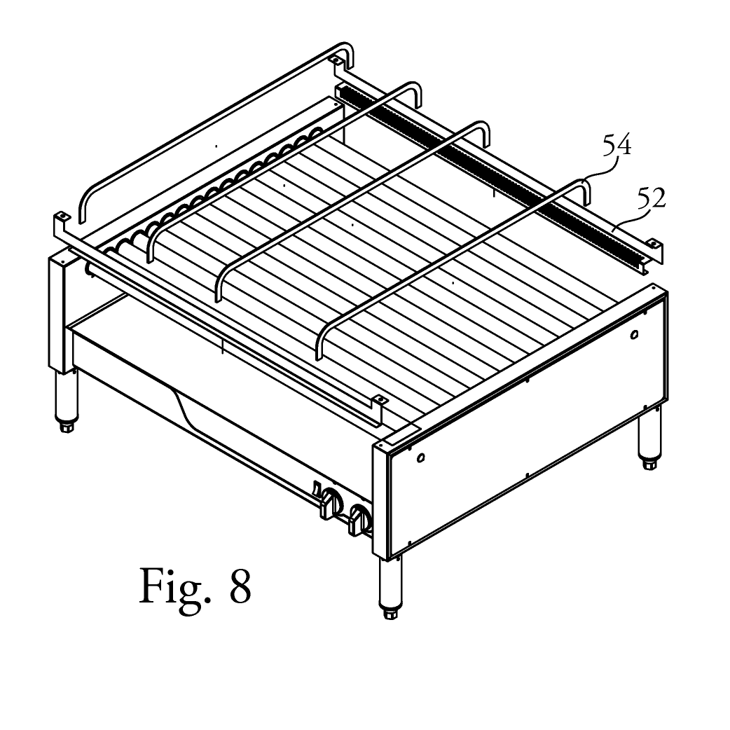

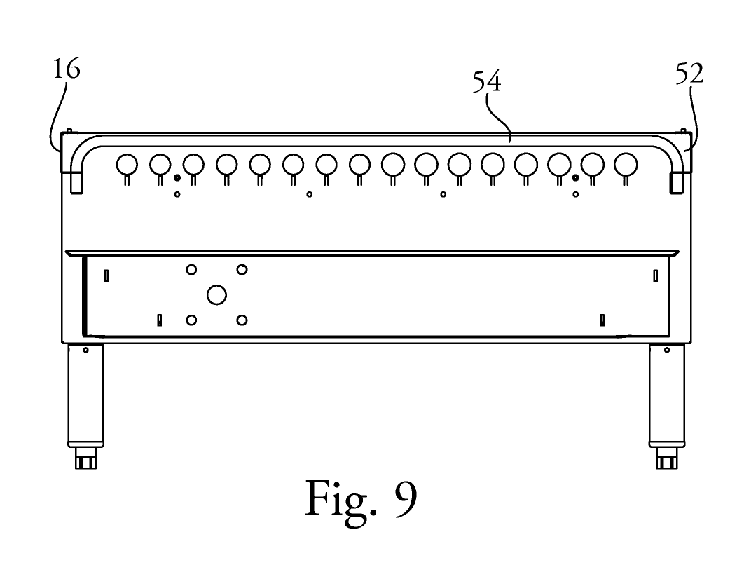

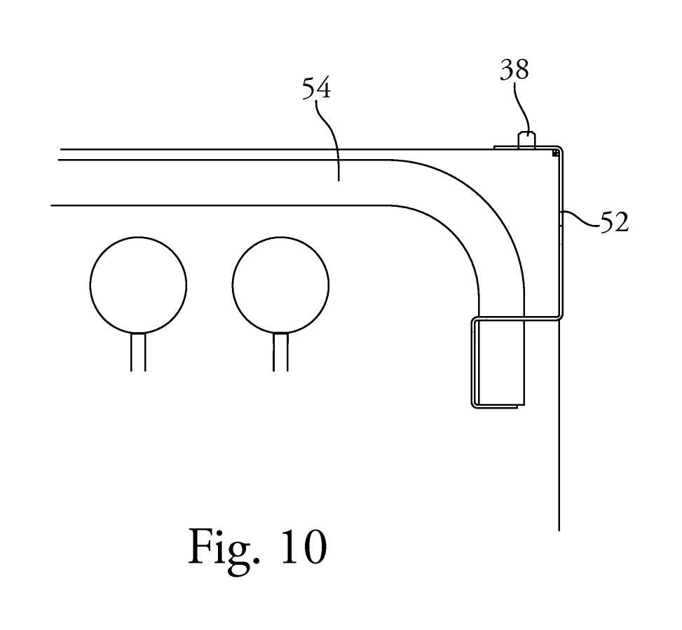

As shown in FIGS. 7, 8, 9 and 10, an alternative embodiment of invention 10 is provided. In this embodiment, both the front and the rear of roller grill 12 are unobstructed. This version uses a U-shaped divider bar 54 and rear rail 52. As shown in FIGS. 9 and 10, U-shaped bar 54 uses the same front rail 16 and rear rail 52 to attach the apparatus to roller grill 12. Rear rail 52 is the mirror image of front rail 16. Rear rail 52 is attached to panels 20 and 22 using pins 38 and openings 39 as in the preferred embodiment.

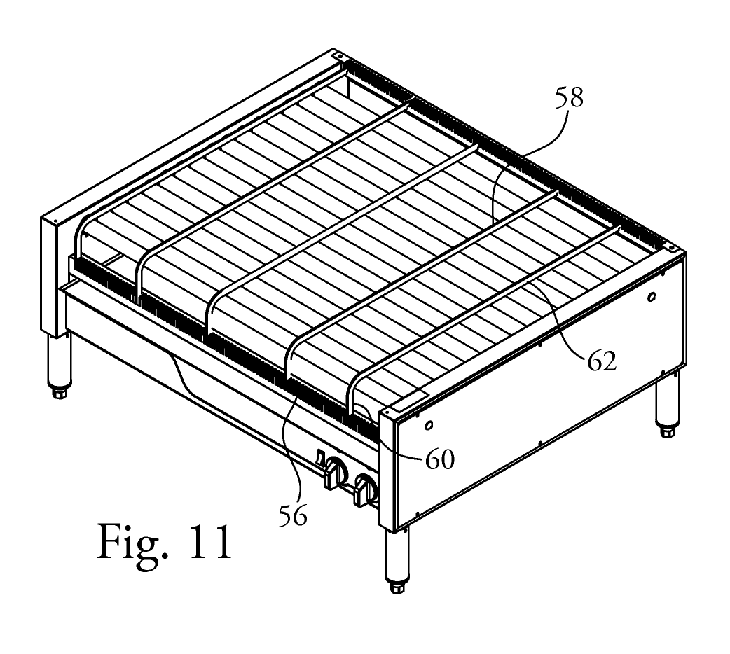

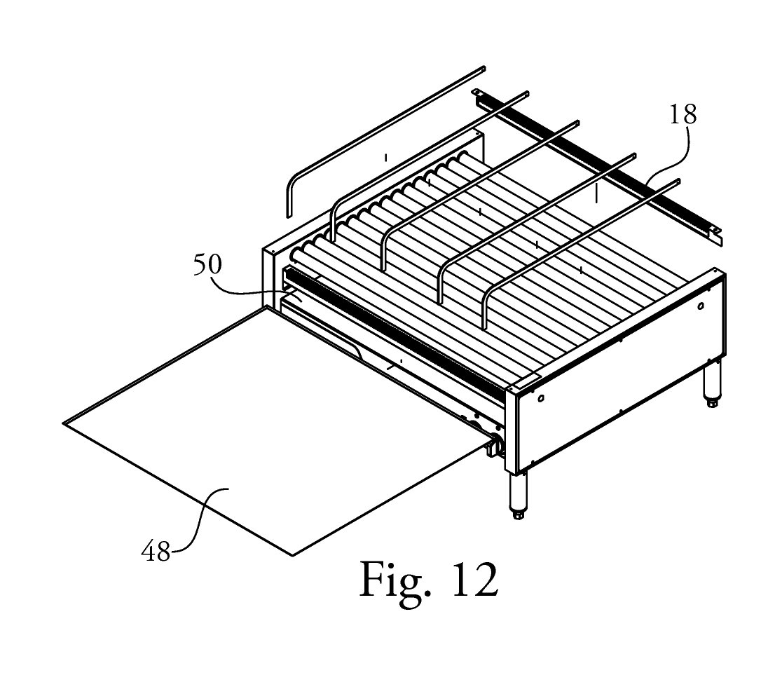

Referring now to FIGS. 11, 12, 13, and 14, another embodiment of invention 10 is described. In this embodiment, front rail 56 is used with L-shaped bar 58. Leg 62 of bar 58 would be comparable in length to leg 36 of bar 14 if fitted to the same size roller grill 12. However, leg 60 of bar 58 will be longer than leg 34 of bar 14 in order to have front rail 56 sit on floor 50 of roller grill 12. Rear rail 18 can be the same used for the embodiment shown in FIGS. 1, 2.

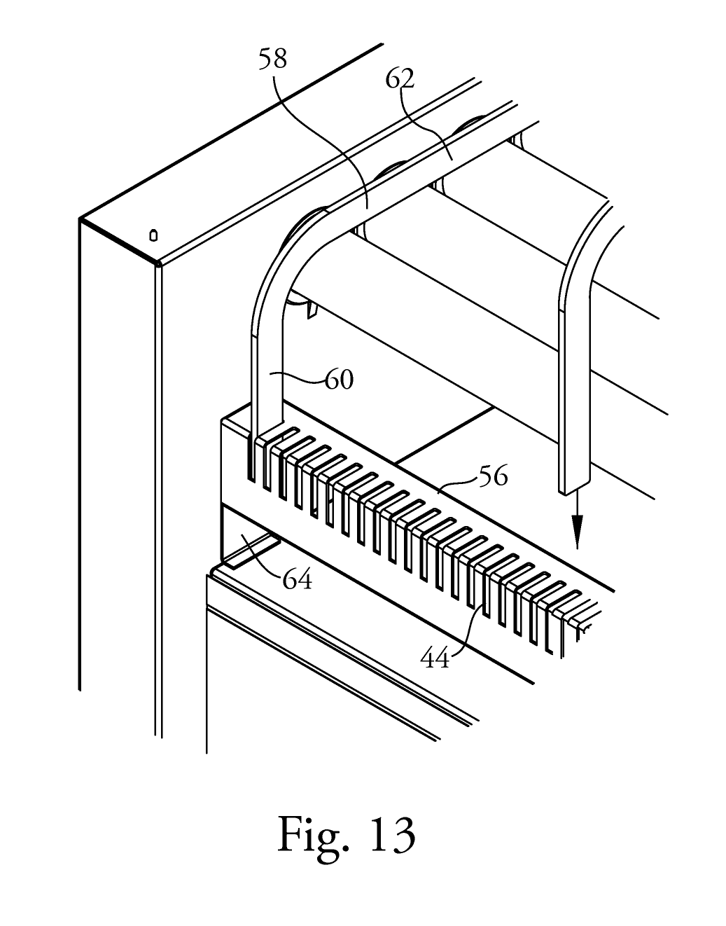

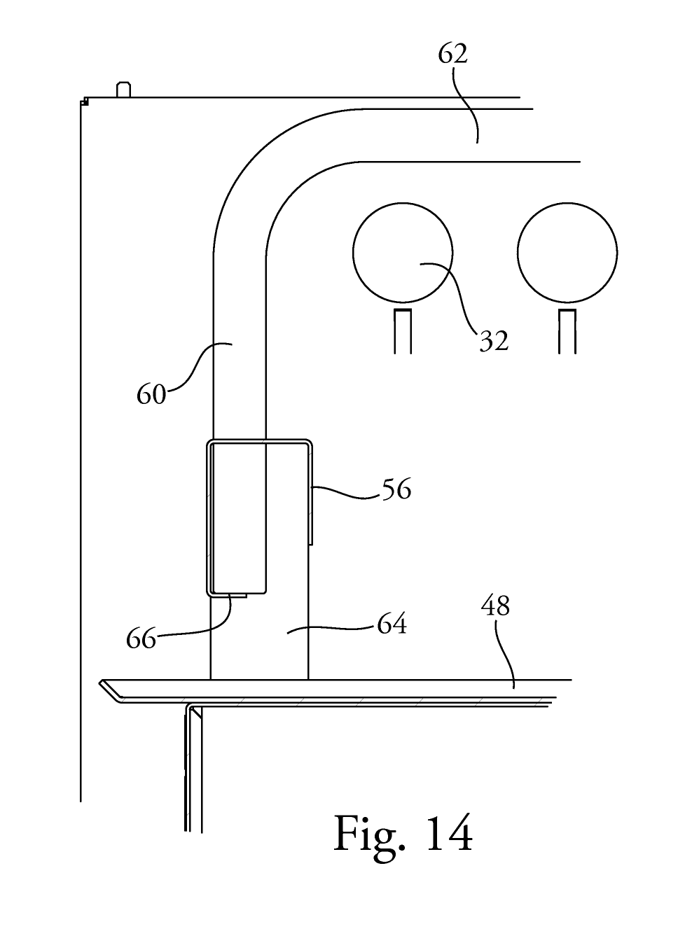

In this embodiment, front rail 56 is closer to pan 48 as shown in FIGS. 13 and 14. Front rail 56 has flange 66 to locate bar 58 at the proper distance from tubes 32 and floor 50. Stand-offs 64 at the respective ends of front rail 56 hold rail 56 off floor 50 so that pan 48 may still be used while keeping invention 10 in place. Front rail 56 and bar 58 are made the same way as bar 14 and front rail 16 in the aforementioned embodiments.

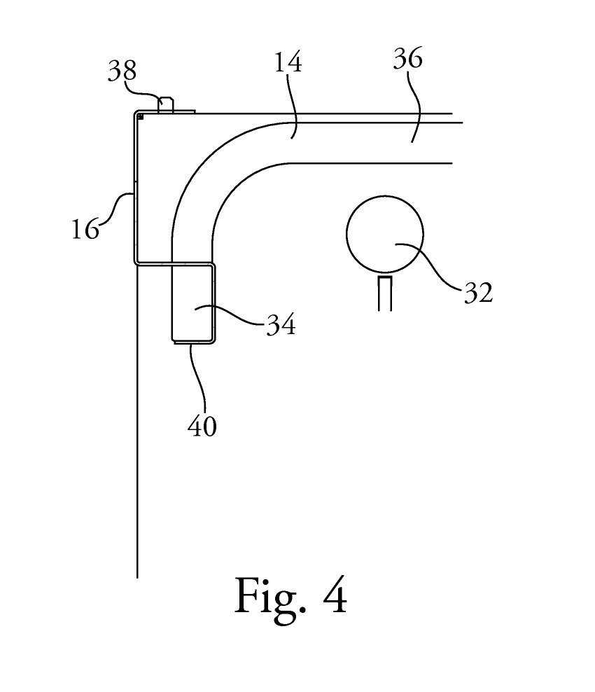

This embodiment could also be configured with both rail 56 and a mirror image of rail 56 (not shown) and a U-shaped bar having a rear leg (not shown) that is comparable to the length of leg 60 such that both the front and rear of the embodiment is resting on floor 50 of roller grill 12. This embodiment could also be configured using front rail 56 as shown and having rear rail 52 shown in FIG. 10 with a U-shaped bar having a length of front leg 60 and a rear leg having a length corresponding to the length of leg 34 as shown in FIG. 4.

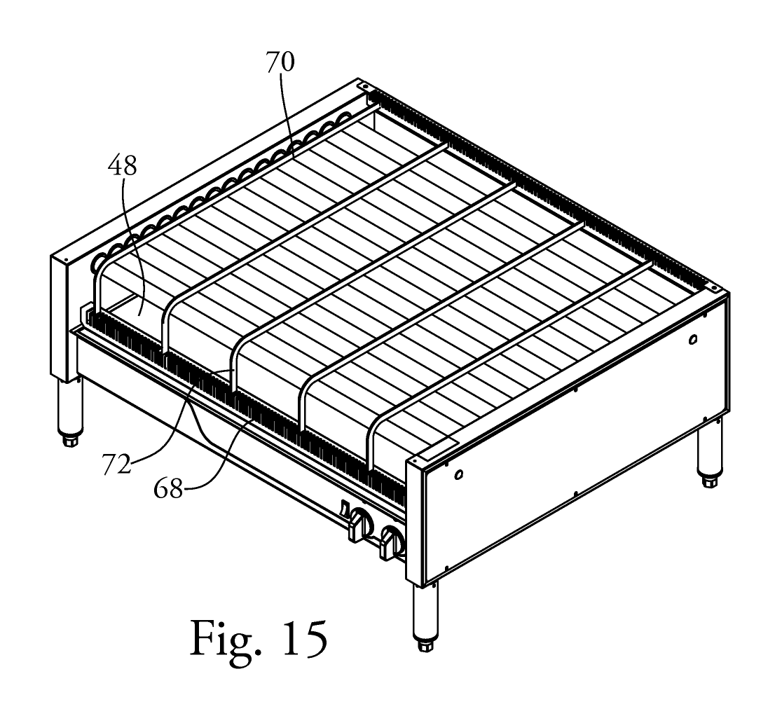

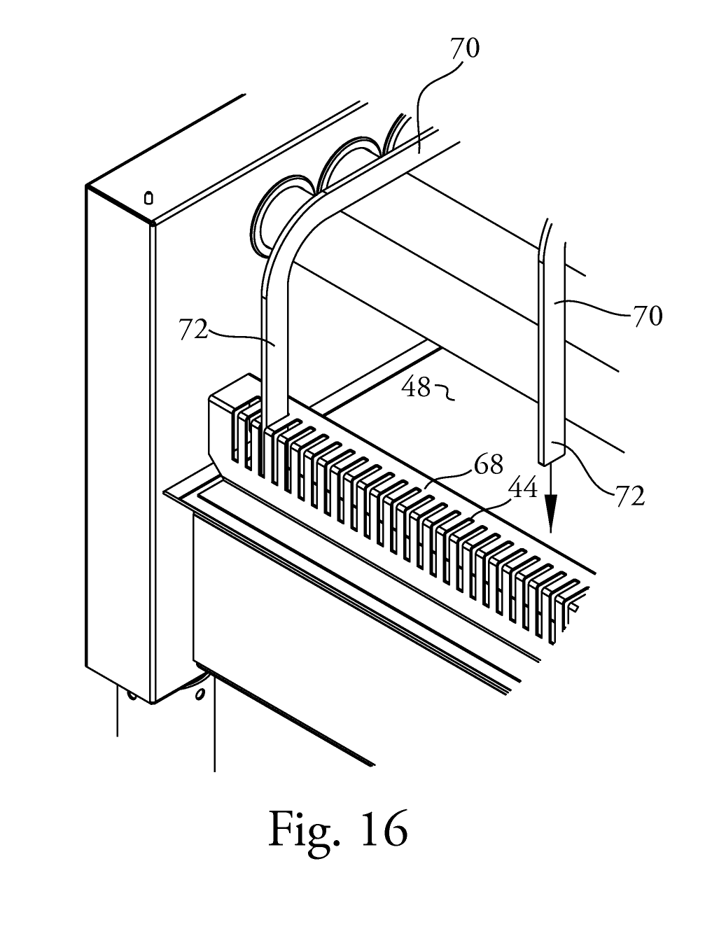

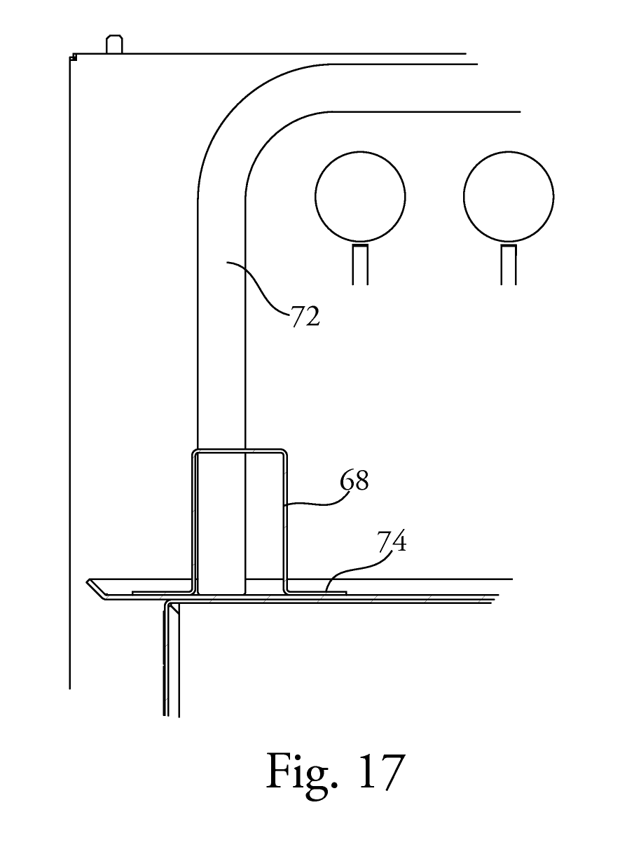

Still another embodiment is shown in FIGS. 15, 16 and 17. In this embodiment, rail 68 sits on pan 48. Bar 70 must have a still longer leg 72 so that bar 70 is properly distanced from roller tubes 32. As before, leg 72 is inserted in a selected slot 44 to divide roller grill 12 into two or more sections.

This embodiment could be configured with rear rail 18 as shown in FIG. 1; with rear rail 52 as shown in FIG. 9; with a rear rail that is a mirror image of front rail 56 as shown in FIG. 14 or with a rear rail that is a mirror image of front rail 68. The divider bars would be configured accordingly.

In summary, a variety of configurations is possible as long as at least the front rail of each configuration is lower than roller tubes 32 so that the rail/divider bar combination does not obstruct roller tubes 32; that is, all variations or combinations are possible except using a mirror image of rail 18 as a front rail which would defeat the advantages provided by the invention.

Although the present invention has been described with reference to certain preferred embodiments thereof, other versions are readily apparent to those of ordinary skill in the preferred embodiments contained herein.

What is claimed is:

1. A roller grill divider assembly for a roller grill having a cooking surface, the cooking surface having a front edge and a rear edge wherein the cooking surface is provided by a plurality of aligned tubular rollers wherein said roller grill divider assembly comprises:
at least one L-shaped divider bar with each at least one L-shaped bar having a front leg and a horizontal leg and wherein said at least one L-shaped divider bar divides the cooking surface of the roller grill into cooking sections;
a front rail having a plurality of slots, wherein said front rail is releasably attached to the roller grill adjacent to the front edge of the cooking surface below the cooking surface of the grill;
a rear rail having a plurality of slots corresponding to and aligned with said slots in said front rail wherein said rear rail is releasably attached to the roller grill adjacent to the rear edge of said cooking surface; wherein
said front leg of each at least one L-shaped divider bar is placed in one of said plurality of slots in said font rail and its said horizontal leg of each at least one L-shaped divider bar is placed in the corresponding and aligned slot of said rear rail such that the cooking surface is divided into at least two cooking sections and such that said front leg of each said at least one L-shaped divider bar is below the cooking surface of the grill and with horizontal leg being above the cooking surface of the grill.

2. The roller grill divider assembly of claim 1 wherein said horizontal leg of each said at least one divider bar further comprises attachment means for releasably holding said at least one divider bar in position in said corresponding pair of slots provided by said front rail and said rear rail.

3. The roller grill divider assembly of claim 2 wherein said means for attachment in each horizontal leg of said at least one divider bar is a notch.

4. The roller grill divider assembly of claim 1 wherein each at least one L-shaped divider bar has a length corresponding to the distance between the front edge of the cooking surface to the rear edge of the cooking surface.

5. A roller grill divider assembly for a roller grill having a cooking surface, the cooking surface having a front edge and a rear edge wherein the cooking surface is provided by a plurality of aligned tubular rollers wherein said roller grill divider assembly comprises:
at least one U-shaped divider bar with each at least one bar having a front leg, a rear leg and a horizontal leg between said front leg and said rear leg and wherein said at least one U-shaped divider bar divides the cooking surface of the roller grill into at least two cooking sections;
a front rail having a plurality of slots, wherein said front rail is releasably attached to the roller grill adjacent to the front edge of the cooking surface below the cooking surface of the grill;
a rear rail having a plurality of slots corresponding to and aligned with said slots in said front rail wherein said rear rail is releasably attached to the roller grill adjacent to the rear edge of said cooking surface below the cooking surface of the grill; wherein
said front leg of each at least one U-shaped divider bar is placed in one of said plurality of slots in said font rail and its said rear leg of each at least one U-shaped divider bar is placed in the corresponding and aligned slot of said rear rail such that the cooking surface is divided into at least two cooking sections and such that said front leg and said rear leg of each said at least one U-shaped divider bar is below the cooking surface of the grill with said horizontal leg being above the cooking surface of the grill.
